(19) United States
(12) Patent Application Publication
(10) Pub. No.: US 2023/0267314 A1
(43) Pub. Date: Aug. 24, 2023

(54) Automated thresholding of binary classification ML models

(71) Applicant: Google LLC, Mountain View, CA (US)

(72) Inventors: Madhav Datt, Bangalore (IN); Prakhar Gupta, Bangalore (IN)

(21) Appl. No.: 17/944,892

(22) Filed: Sep. 14, 2022

Related U.S. Application Data
(60) Provisional application No. 63/313,158, filed on Feb. 23, 2022.

(51) Int. Cl. G06N 3/04; G06F 21/64

(52) U.S. Cl. CPC G06N 3/0481; G06F 21/64

(57) ABSTRACT

Methods and systems are provided for generating, for respective mutually exclusive classes of model inputs, separate output thresholds that can be applied to the continuous-valued output of a neural network or other machine learning model in order to classify inputs in a class-sensitive manner. Such classes could be related to operational or other constraints with respect to the classifier outputs that vary across the classes of inputs. Thus, the machine learning model can be improved by using training data from all of the available classes while allowing the end performance of the model plus threshold classifier to be separately set for each input class. These automated methods for class-specific threshold setting also provide improvements with respect to accuracy, time, and cost. Also provided are methods and systems for per-class calibration of model outputs.

### CROSS-REFERENCE TO RELATED APPLICATION

This application claims the benefit of and incorporates by reference the content of U.S. Provisional App. No. 63/313,158, filed Feb. 23, 2022.

### BACKGROUND

In many applications, a machine learning model (e.g., an artificial neural network, a support vector machine, a regression tree) can be trained to classify an input (e.g., determine whether an input image contain a face) by generating a continuous-valued intermediate output and then applying a threshold to the intermediate output to generate a discrete-values binary output classification. The process of setting such thresholds can be part of the model training process. However, in many applications the threshold-setting process depends upon a variety of considerations, making it difficult to perform in an automated fashion. Thus, many applications include the use of manual threshold-setting, in order to leverage human intuition to set thresholds in view of a range of different factors. However, such manual threshold setting can be expensive, prone to error, and slow.

### SUMMARY

In a first aspect, a computer-implemented method is provided that includes: (i) obtaining input data, wherein the input data includes a plurality of input samples; (ii) assigning each input sample of the input data to a respective slice of a plurality of slices; (iii) for each slice in the plurality of slices, obtaining a respective at least one constraint and a respective at least one metric; (iv) obtaining a trained machine learning model; (v) determining a respective output threshold value for each slice in the plurality of slices, wherein determining a particular output threshold value for a particular slice in the plurality of slices comprises: (a) applying each input sample of the input data that corresponds to the particular slice to the trained machine learning model to generate a plurality of model outputs corresponding to the particular slice; (b) determining at least two putative values of the particular output threshold value that, when applied to the plurality of model outputs corresponding to the particular slice, satisfy the at least one constraint for the particular slice; and (c) selecting, from the at least two putative values, the particular output threshold value for the particular slice by determining which of the at least two putative values, when applied to the plurality of model outputs corresponding to the particular slice, result in a maximal value of the at least one metric for the particular slice; and (vi) providing the respective output threshold value determined for each slice in the plurality of slices for application with the trained machine learning model.

In a second aspect, a non-transitory computer readable medium is provided having stored therein instructions executable by a computing device to cause the computing device to perform the method of the first aspect.

In a third aspect, a system is provided that includes: (i) a controller comprising one or more processors; and (ii) a non-transitory computer readable medium having stored therein instructions executable by the controller device to cause the one or more processors to perform the method of the first aspect.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates aspects of an example method for applying slice-specific calibrations and thresholds to the outputs of a model.

FIG. 2 illustrates aspects of an example method for determining a calibration and threshold value for outputs of a model that correspond to a particular slice of input data.

FIG. 3A illustrates experimental results.

FIG. 3B illustrates experimental results.

FIG. 3C illustrates experimental results.

FIG. 3D illustrates experimental results.

FIG. 4 illustrates aspects of an example system.

FIG. 5 illustrates a flowchart of an example method.

FIG. 6 illustrates a flowchart of an example method.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. Overview

A variety of machine learning models (e.g., artificial neural networks) generate continuous-valued outputs or outputs that otherwise range across a span of possible values (e.g., a range of possible discrete values). These outputs are then thresholded to generate a discrete-valued (e.g., binary) output that can then be used to perform some downstream analysis or to take some further action (e.g., to classify a map update as fraudulent or non-fraudulent and update, or not update, a map database accordingly). The process of setting such thresholds can be part of the model training process. However, in many applications the threshold-setting process depends upon a variety of factors, some of which may be difficult to assess or quantify, making it difficult to perform in an automated fashion. Instead, many applications include the use of manual threshold-setting in order to leverage human intuition to set thresholds in view of a range of different factors. Such factors can include the cost (in time, computational resources, quality control resources) of increasing or decreasing the value of the threshold (resulting in, e.g., an increase or decrease in the number of incidents requiring manual review), changes in user experience related to increasing or decreasing the threshold value (resulting in, e.g., an impeded user experience related to increasing or decreasing the number of user interactions that are blocked or otherwise impeded), compliance with predetermined system requirements (e.g., a predefined requirement to ‘fail’ no more than a set fraction or numbers of inputs/incident), or other factors.

This difficulty in threshold-setting is multiplied when multiple thresholds, related to respective ‘slices’ of possible inputs, must be set for a model that is trained based on data representing all of the slices. Each slice of the data could represent a respective non-overlapping set of users or other non-overlapping subset of past or future inputs for which the factors pertinent to threshold setting differ. For example, the different slices could represent respective different classes of users for whom predetermined system requirements (e.g., with respect to model output classification accuracy, minimum or maximum ‘pass’/‘fail’ fractions) differ, or whose relationship with an entity providing a service differ (e.g., trusted users vs. non-trusted users, users who own a business represented in a maps database vs. other users). Accordingly, it can be advantageous to train a single model based on inputs from such different slices, and to apply such a single trained model to perform inference for inputs corresponding to such different slices while also being advantageous to apply different, slice-dependent thresholds to the output of the common model in order to inform downstream actions/analyses.

The embodiments described herein provide systems and methods for generating or updating (e.g., as additional data is obtained and/or following update of the trained model) slice-specific thresholds for the outputs of a trained machine learning model based on a set of constraints and metrics that may differ between the slices. These embodiments include, for each slice of the data, first determining a plurality of potential threshold values (e.g., at least one continuous range of threshold values and/or two or more discrete threshold values) that comport with one or more constraints defined for the slice; and then applying at least one metric to the determined potential threshold values to select one threshold value that is improved, relative to other potential threshold values, with respect to the metric(s).

The threshold values determined in such a manner could be determined for the ‘raw’ output of the trained model. However, it can be advantageous to perform calibration (e.g., Platt calibration) on the raw output values to generate improved, calibrated output values and to determine the slice-specific threshold values in the space of such calibrated output values. For some data sets, slice-specific metrics determined from the outputs of the model could be highly dependent on the specifics of the slice (e.g., to a small number or non-uniform distribution of the input data samples in the slice). Accordingly, it can also be beneficial to perform calibration of the model output on a per-slice basis. Such per-slice calibration could be used in the context of per-slice threshold determination (e.g., to further improve the final model output classes by further improving the determined slice-specific thresholds). Additionally or alternatively, such slice-specific thresholding could be applied in other contexts, e.g., to reduce the noise of or otherwise improve slice-specific metrics, to improve downstream analysis based on the model output, etc. To reduce the computational cost of performing such a per-slice calibration (or per-slice threshold setting) in a cloud computing context or other pipelined computational context, the raw model outputs could be bucketized by slice, and the bucketized outputs for each slice could then be used to determine the respective per-slice output calibrations (and/or per-slice output thresholds).

The embodiments described herein provide a variety of technical benefits, including reducing the memory requirement or other computational costs of calibrating the output of a machine learning model and/or determining output threshold values for such a machine learning model. These benefits can be realized in an online pipeline-style environment (e.g., TensorFlow or TFX) where inputs are computed individually, such that retaining intermediate results (e.g., un-calibrated or calibrated model outputs) for each input is expensive with respect to memory or other computational costs.

As used herein, a “constraint” is a set of one or more requirements with respect to which a particular putative threshold value may ‘pass’ or ‘fail’ when applied to a set of inputs of a particular slice. For example, a “constraint” could be a requirement that no more than 65% of the inputs of a slice be classified as “fraudulent” (or some other class label) by thresholding the output of a machine learning model. Thus, evaluating a “constraint” with respect to a particular slice of input data and a particular threshold value may include evaluating a number of separate functions (themselves potentially usable individually as “constraints”) and then determining whether the particular threshold value satisfies all of the functions or some other specified number or fraction of the functions.

As used herein, a “metric” is a function that describes a quality of the classification of a set of inputs of a slice by thresholding the output of machine learning model. For example, a marginal precision of classification of inputs by applying the inputs to a machine learning model and then threshold the outputs using a particular threshold value could be determined and used as a metric. Such a metric may be discrete-valued (e.g., could have a discrete set of possible outputs spanning a range of values) or continuous-valued.

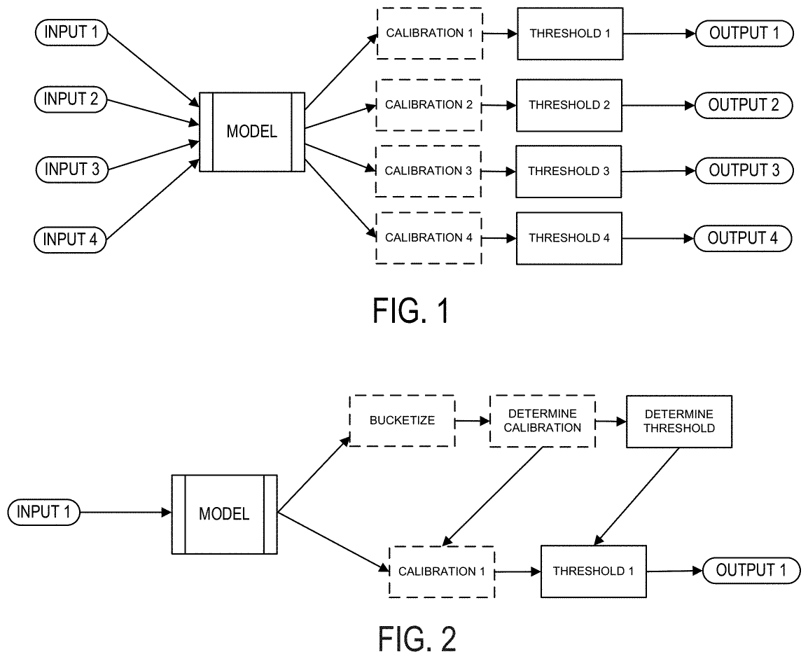

FIG. 1 depicts, in a non-limiting example embodiment, elements of a process for using a common machine learning model (“MODEL,” e.g., an artificial neural network, a support vector machine, a regression tree) to classify inputs that correspond to a number of mutually-exclusive slices (“INPUT 1,” “INPUT 2,” “INPUT 3,” “INPUT 4”) of input data (e.g., user inputs representing updates to a map database), thereby classifying (“OUTPUT 1,” “OUTPUT 2,” “OUTPUT 3,” “OUTPUT 4”) each of the inputs (e.g., determining whether each of the inputs is likely to be a fraudulent and/or inaccurate update to the map database). This process includes applying inputs from each slice to the common model to generate intermediate outputs to which a slice-specific threshold (“THRESHOLD 1,” “THRESHOLD 2,” “THRESHOLD 3,” “THRESHOLD 4”) is applied in order to classify the inputs. To improve the classification of the model intermediate outputs, the intermediate output may be applied to a calibration function prior to being thresholded. Such a calibration function may be common across all slices, or may be performed using slice-specific calibration functions (“CALIBRATION 1,” “CALIBRATION 2,” “CALIBRATION 3,” “CALIBRATION 4”).

The different mutually-exclusive ‘slices’ of the input data may represent different sources of the input data, different types of input data, different periods of generation of the input data, different geographic sources of the input data, different types of users from whom the input data are received, or some other mutually-exclusive partitioning of input data. For example, the different slices could represent respective different classes of users for whom contractual agreements (e.g., with respect to model output classification accuracy, minimum or maximum ‘pass’/‘fail’ fractions) differ, or whose relationship with an entity providing a service differ (e.g., trusted users vs. non-trusted users, users who own a business represented in a maps database vs. other users).

An underlying mechanism or property of interest, which is sought to be predicted by the model, could be the same or similar across the slices of input data. Thus, it could be advantageous to apply the same predictive model to inputs from all of the slices, and to use training data from all of the slices in order to improve the quality of the trained model (e.g., by providing a larger and more diverse corpus of training examples). However, as noted above, contractual obligations, relationship goals or histories, levels of trust, willingness to provide services, or other factors could differ across the slices of input data, making it advantageous to use slice-specific thresholds (and optionally slice-specific calibration) on the intermediate outputs of the trained model in order to generate the final classification of each input.

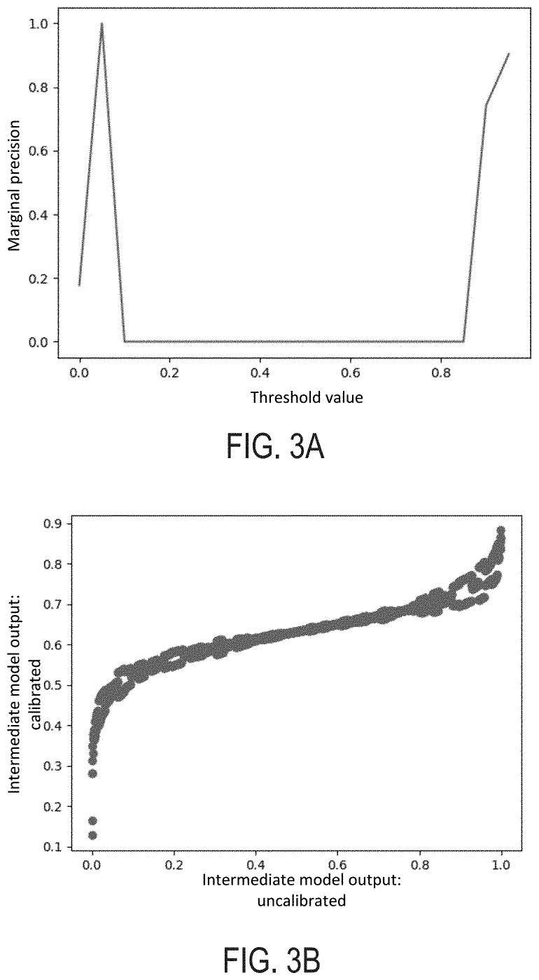

As noted above, the per-slice thresholds can be determined manually. However, such a manual process can be expensive, inaccurate, and slow. Instead, the methods disclosed herein may be applied to generate such thresholds (and, optionally, calibration data) on a per-slice basis in an automated manner, reducing costs, improving threshold accuracy, and allowing the thresholds to be updated on a more frequent basis (e.g., as new training inputs are received, as the common model is updated, etc.). FIG. 2 depicts, in a non-limiting example embodiment, elements of such a process for generating, for a particular slice of input data (“INPUT 1”), a slice-specific threshold value (“THRESHOLD 1”) (and, optionally, a slice-specific intermediate output calibration curve (“CALIBRATION 1”)) that can be applied to the model intermediate output generated from the input in order to determine an output classification (“OUTPUT 1”) for the input. A slice-specific threshold determined in this manner is determined to satisfy one or more slice-specific constraints while also providing for increased performance, relative to alternative constraint-satisfying possible threshold values, with respect to one or more metrics.

The process of FIG. 2 includes applying training inputs that correspond to a particular slice (“INPUT 1”) to the common model (“MODEL”) in order to generate corresponding intermediate model outputs. These intermediate model outputs can then be used, in combination with “ground truth” labels for the training inputs, to determine the slice-specific threshold (“DETERMINE THRESHOLD”) for the particular slice.

To determine the slice-specific threshold, the one or more slice-specific constraints are evaluated, based on the “ground truth” labels for the inputs and the set of model intermediate outputs determined from the inputs, for a plurality of possible threshold values that span a range of possible threshold values. So, for example, if the output of the model is bounded on [0,1], the set of possible threshold values could include a plurality of discrete values spanning the range [0,1] (e.g., [0.0, 0.1, 0.2, . . . , 0.9, 1.0], [0.1, 0.2, 0.3, . . . , 0.8, 0.9], [0.00, 0.01, 0.02, . . . , 0.99, 1.00], [0.01, 0.02, 0.03, . . . , 0.98, 0.99]). The set of discrete possible threshold values could be regularly spaced across the range, randomly or pseudo-randomly selected, could be logistically or exponentially spaced, or could span a range of threshold values in some other way. This repeated evaluation of the one or more constraints could result in a set of putative threshold values, which satisfy the one or more constraints with respect to the inputs.

The one or more slice-specific constraints could include a variety of different constraints. For example, the one or more constraints could include maximum of minimum values with respect to model precision, incorrect decision rate, or some other constraint that may be relevant to a user experience, a cost of action related to false positive classification, a cost of action or database degradation related to false negative classification, a contractual obligation, or some other factor relevant to the pattern of correct and incorrect classification of the available input samples for each of the possible threshold values.

In examples where only one putative threshold value is determined, that single putative threshold value could be selected as the slice-specific threshold value (e.g., without additionally evaluating a metric for the single putative threshold value). However, in cases where two or more putative threshold values are determined to satisfy the one or more constraints, a metric (which could be slice-specific) could be determined for each of the putative threshold values and the putative threshold value with the greatest (or least, depending on the metric) metric value could then be selected as the slice-specific threshold value. This avoids the computational cost of determining the metric for possible threshold values that do not satisfy the constraint (i.e., possible threshold values that are not putative threshold values), thereby reducing the computational cost of determining a slice-specific threshold value that satisfies the constraint(s) and that is also ‘better,’ with respect to the metric, than other constraint-satisfying threshold values. Where two or more putative threshold values ‘tie’ with respect to the metric, a secondary metric can be determined to break the ‘tie,’ with the winner being selected as the slice-specific threshold value. Alternatively, ‘tie’ could be broken by randomly selecting the slice-specific threshold value from the ‘winners’ with respect to the metric, selecting the greatest (or least) slice-specific threshold value from the ‘winners’ with respect to the metric, or selecting the slice-specific threshold value form the ‘winners’ with respect to the metric via some other process.

As noted above, the slices differ with respect to the population of input data that is mutually exclusively assigned thereto. Accordingly, the distribution of intermediate model output values, ‘ground truth’ labels, sample size, or other properties of the population of input data associated with each slice can vary significantly, leading to difficulties in determining metrics (e.g., increased variance or decreased accuracy) and/or selecting slice-specific threshold values. Accordingly, it can be advantageous to also determine slice-specific calibration curves (“DETERMINE CALIBRATION”) for each of the slices in order to regularize and smooth the intermediate model outputs that are used to determine constraints, metrics, and/or threshold values for a slice of input. This can be beneficial even in examples where the model has been trained to predict class probabilities directly, e.g., to correct for variation in the distribution of intermediate outputs from slice to slice, to account for small sample size slices, etc.

The distribution of intermediate model outputs determined from the inputs of a particular slice can be determined and then used to generate the calibration data, e.g., to scale the intermediate model outputs such that the distribution of the intermediate model outputs following calibration comports with a specified distribution. This could include determining parameters of a calibration function ƒ such that y_{calibrated}=ƒ(y_{predicted}), where y_{predicted} is the uncalibrated intermediate model output and y_{calibrated} is the calibrated intermediate model output. The calibration curve could be a sigmoid, e.g., y_{calibrated}=σ(w*y_{predicted}+b), where σ is the sigmoid function and w and b are per-slice slope and offset parameters determined as part of the per-slice calibration process. In some examples, Platt scaling or some other scaling method could be applied to determine the calibration.

Such per-slice thresholds and/or calibration data could then be re-computed and updated over time according to a set schedule (e.g., once per month) and/or in response to the occurrence of set conditions. For example, the thresholds and/or calibration data could be re-computed in response to training or otherwise obtaining an updated version of the machine learning model (e.g., an update model trained using training data obtained since the computation of the previous version of the model). Additionally or alternatively, the thresholds and/or calibration data could be re-computed in response to obtaining a set amount of additional inputs on which to base such an update (e.g., to reflect ongoing changes in the distribution of the inputs on a per-slice basis). Such an update could be performed on a per-slice basis (e.g., only updating the threshold and/or calibration data for a slice once a set amount of new input corresponding to that slice have been obtained) and/or for all slices at the same time.

In some situations, it can be computationally difficult to generate per-slice thresholds and/or calibration data as described above. For example, where a large number of inputs are available for a slice, it can be undesirable to maintain records related to all of the inputs (e.g., intermediate model outputs, class or label of the inputs, weights related to the ‘importance’ of the inputs) in order to later generate thresholds and/or calibration data therefrom. This can be the case in pipelined machine learning model computational environments (e.g., the TensorFlow cloud computing environment) where the compute tasks related to each input are computed serially (e.g., applying an input to a model, applying an intermediate output of the model to calibration curve to generate a calibrated output, and then applying a threshold to the calibrated output to classify the input).

To reduce the storage requirements or other computational costs of determining the per-slice thresholds and/or calibration data, a range of possible model intermediate outputs values could be discretized, with inputs corresponding to each non-overlapping discrete range of the intermediate output being represented by a single ‘bucket.’ Such a ‘bucketized’ representation of the inputs for a particular slice can then be used to determine threshold values, calibration data, or other information for the particular slice. “Bucketizing” the data for a slice in this manner reduces the storage requirements (from N records, corresponding to the N relevant inputs for the slice to a specified constant k buckets), memory requirements, and computational cost of determining threshold values and calibration data for each slice. The number of buckets could be selected based on a desired smoothness, threshold resolution, memory/compute cost, etc. For example, the number of buckets could be set to 100, 1000, or some other power of ten.

A variety of information could be accumulated for each bucket based on the set of input samples that correspond to the bucket (i.e., the set of input samples whose intermediate output values, as output from the model, correspond to the range of values encompassed by the bucket). For example, a count of inputs corresponding to each of the two classes of inputs (to be separated as above/below the threshold to be determined) could be stored for each bucket. That is, each bucket b would have a count C¹_{b} of the number of input samples that are ‘true’ (i.e., that should be assigned to a first class via thresholding) and a count C⁰_{b} of the number of input samples that are ‘false’ (i.e., that should be assigned to a second class, that is disjoint form the first class, via thresholding). Additionally or alternatively, each input sample could be associated with a weight, and the sum of the weights of inputs corresponding to each of the two classes of inputs could be stored for each bucket. That is, each bucket b would have a value W¹_{b} of the sum of the weights of input samples that are ‘true’ (i.e., that should be assigned to a first class via thresholding) and a value W⁰_{b} of the sum of the weights of input samples that are ‘false’ (i.e., that should be assigned to a second class, that is disjoint form the first class, via thresholding). Such weights could represent a number of events, user inputs, or other discrete entities corresponding to an input, a relative importance of the input (e.g., a level of confidence that the input represents useful data), or some other weight.

The per-slice threshold and/or calibration data can then be determined for a particular slice of the input data based on the bucketized data determined for the particular slice as described above. Such bucketized data could also be used to evaluate whether possible threshold values satisfy one or more constraints, to determine metric values in order to compare different constraint-satisfying threshold values, or to perform some other operation or analysis of the inputs that correspond to a particular slice or set of slices of input data.

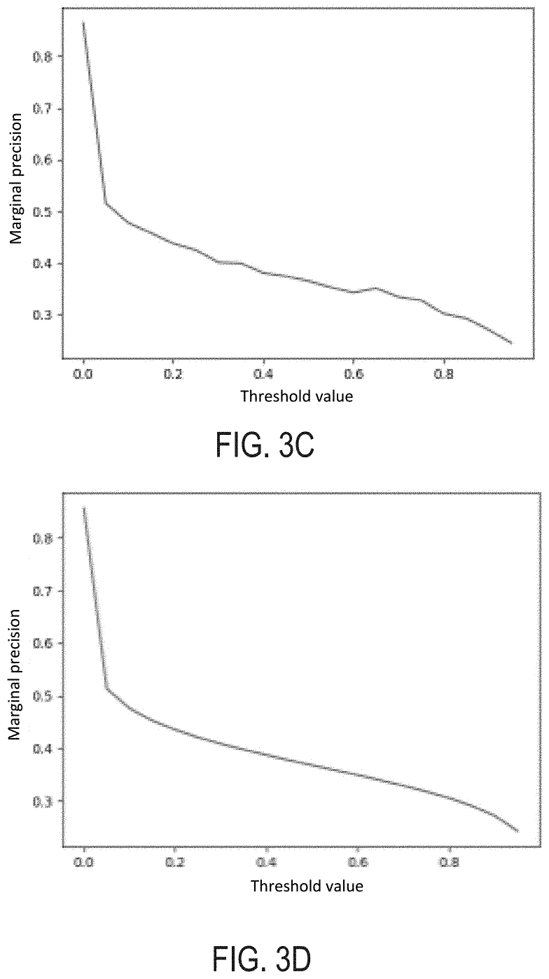

The methods described herein were experimentally evaluated. An example slice of input data was applied to a trained machine learning model to generate uncalibrated intermediate outputs. A range of discrete possible threshold values were then assessed with respect to marginal precision. The result of this analysis is depicted in FIG. 3A, which shows that the uncalibrated intermediate outputs result in undesirable outcomes with respect to the ability of the thresholded uncalibrated intermediate outputs to distinguish the two classes of inputs. A calibration curve was then determined for the intermediate outputs using Platt scaling. FIG. 3B shows a plot of the calibrated outputs as a function of the uncalibrated outputs. FIG. 3C shows the same range of discrete possible threshold values as in FIG. 3A, now assessed with respect to marginal precision in classifying the inputs based on the calibrated outputs. The calibrated outputs are improved relative to the uncalibrated outputs.

Using bucketized outputs to determine the threshold values results in similar outcomes to non-bucketized outputs. FIG. 3D depicts the same analysis as in FIG. 3C, except that the data used to determine the calibration was bucketized into 1000 discrete buckets.

### II. Example Systems

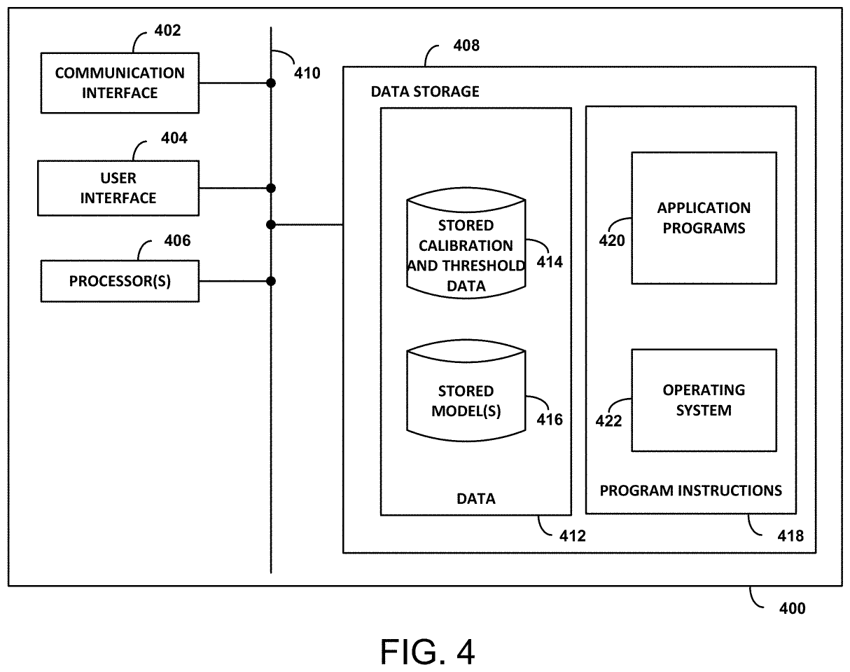

FIG. 4 illustrates an example system 400 that may be used to implement the methods described herein. By way of example and without limitation, system 400 may be or include a computer (such as a desktop, notebook, tablet, or handheld computer, a server), elements of a cloud computing system, or some other type of device or system. It should be understood that elements of system 400 may represent a physical instrument and/or computing device such as a server, a particular physical hardware platform on which applications operate in software, or other combinations of hardware and software that are configured to carry out functions as described herein.

As shown in FIG. 4, system 400 may include a communication interface 402, a user interface 404, one or more processor(s) 406, and data storage 408, all of which may be communicatively linked together by a system bus, network, or other connection mechanism 410.

Communication interface 402 may function to allow system 400 to communicate, using analog or digital modulation of electric, magnetic, electromagnetic, optical, or other signals, with other devices (e.g., with databases that contain sets of training inputs or related data, e.g., map data that can be updated based on additional user inputs), access networks, and/or transport networks. Thus, communication interface 402 may facilitate circuit-switched and/or packet-switched communication, such as plain old telephone service (POTS) communication and/or Internet protocol (IP) or other packetized communication. For instance, communication interface 402 may include a chipset and antenna arranged for wireless communication with a radio access network or an access point. Also, communication interface 402 may take the form of or include a wireline interface, such as an Ethernet, Universal Serial Bus (USB), or High-Definition Multimedia Interface (HDMI) port. Communication interface 402 may also take the form of or include a wireless interface, such as a Wifi, BLUETOOTH®, global positioning system (GPS), or wide-area wireless interface (e.g., WiMAX, 3GPP Long-Term Evolution (LTE), or 3GPP 5G). However, other forms of physical layer interfaces and other types of standard or proprietary communication protocols may be used over communication interface 402. Furthermore, communication interface 402 may comprise multiple physical communication interfaces (e.g., a Wifi interface, a BLUETOOTH® interface, and a wide-area wireless interface).

In some embodiments, communication interface 402 may function to allow system 400 to communicate, with other devices, remote servers, access networks, and/or transport networks. For example, the communication interface 402 may function to communicate with one or more servers (e.g., servers of a cloud computer system that provide computational resources for a fee) to provide images and to receive, in response, user inputs (e.g., map updates) or other types of input that can be classified in a slice-dependent manner using a model as described herein. In another example, the communication interface 402 may function to communicate with one or more cellphones, tablets, or other computing devices.

User interface 404 may function to allow system 400 to interact with a user, for example to receive input from and/or to provide output to the user. Thus, user interface 404 may include input components such as a keypad, keyboard, touch-sensitive or presence-sensitive panel, computer mouse, trackball, joystick, microphone, and so on. User interface 404 may also include one or more output components such as a display screen which, for example, may be combined with a presence-sensitive panel. The display screen may be based on CRT, LCD, and/or LED technologies, or other technologies now known or later developed. User interface 404 may also be configured to generate audible output(s), via a speaker, speaker jack, audio output port, audio output device, earphones, and/or other similar devices.

Processor(s) 406 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of model execution (e.g., execution of artificial neural networks or other machine learning models), calibration and/or thresholding of model outputs, bucketizing of model outputs, determining calibrations or thresholds for model outputs, or other functions as described herein, among other applications or functions. Data storage 408 may include one or more volatile and/or non-volatile storage components, such as magnetic, optical, flash, or organic storage, and may be integrated in whole or in part with processor(s) 406. Data storage 408 may include removable and/or non-removable components.

Processor(s) 406 may be capable of executing program instructions 418 (e.g., compiled or non-compiled program logic and/or machine code) stored in data storage 408 to carry out the various functions described herein. Therefore, data storage 408 may include a non-transitory computer-readable medium, having stored thereon program instructions that, upon execution by system 400, cause system 400 to carry out any of the methods, processes, or functions disclosed in this specification and/or the accompanying drawings. The execution of program instructions 418 by processor(s) 406 may result in processor 406 using data 412.

By way of example, program instructions 418 may include an operating system 422 (e.g., an operating system kernel, device driver(s), and/or other modules) and one or more application programs 420 (e.g., functions for executing the methods described herein) installed on system 400. Data 412 may include stored calibration and/or threshold data 414 (e.g., continuous or discrete calibration curves for model outputs, thresholds for applying to calibrated or uncalibrated model outputs, bucketized representations of raw and/or calibrated model outputs for use in determining threshold values and/or calibration curves). Data 412 may also include stored models 416 (e.g., stored model parameters and other model-defining information) that can be executed as part of the methods described herein (e.g., to determine, from an input, a raw model output that can then be calibrated and/or applied to a threshold in order to classify the input).

Application programs 420 may communicate with operating system 422 through one or more application programming interfaces (APIs). These APIs may facilitate, for instance, application programs 420 transmitting or receiving information via communication interface 402, receiving and/or displaying information on user interface 404, and so on.

Application programs 420 may take the form of “apps” that could be downloadable to system 400 through one or more online application stores or application markets (via, e.g., the communication interface 402). However, application programs can also be installed on system 400 in other ways, such as via a web browser or through a physical interface (e.g., a USB port) of the system 400.

### III. Example Methods

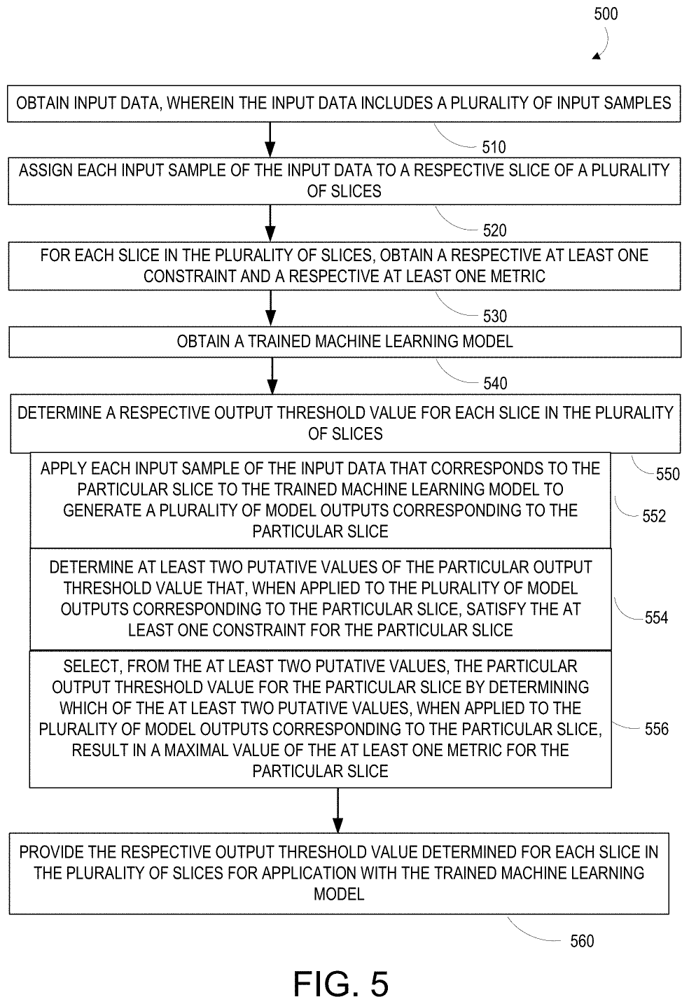

FIG. 5 depicts an example method 500. The method 500 includes obtaining input data, wherein the input data includes a plurality of input samples (510). The method 500 additionally includes assigning each input sample of the input data to a respective slice of a plurality of slices (520). The method 500 also includes, for each slice in the plurality of slices, obtaining a respective at least one constraint and a respective at least one metric (530). The method 500 yet further includes obtaining a trained machine learning model (540). The method 500 additionally includes determining a respective output threshold value for each slice in the plurality of slices (550). Determining a particular output threshold value for a particular slice in the plurality of slices includes: applying each input sample of the input data that corresponds to the particular slice to the trained machine learning model to generate a plurality of model outputs corresponding to the particular slice (552); determining at least two putative values of the particular output threshold value that, when applied to the plurality of model outputs corresponding to the particular slice, satisfy the at least one constraint for the particular slice (554); and selecting, from the at least two putative values, the particular output threshold value for the particular slice by determining which of the at least two putative values, when applied to the plurality of model outputs corresponding to the particular slice, result in a maximal value of the at least one metric for the particular slice (556). The method additionally includes providing the respective output threshold value determined for each slice in the plurality of slices for application with the trained machine learning model (560). The method 500 could include additional steps or features.

It should be understood that arrangements described herein are for purposes of example only. As such, those skilled in the art will appreciate that other arrangements and other elements (e.g. machines, interfaces, operations, orders, and groupings of operations, etc.) can be used instead of or in addition to the illustrated elements or arrangements.

### IV. Example Machine Learning Models and Training Thereof

A machine learning model as described herein may include, but is not limited to: an artificial neural network (e.g., a herein-described neural network, including a graph neural network, convolutional neural network, and/or graph convolutional network, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the generation of inferences, classifications, probabilities, or other outputs based on inputs.

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on molecular structure-encoding graphs or other large-dimensional inputs. An ANN can include a graph neural network (GNN, e.g., a graph convolutional network (GCN)) that is configured to receive a graph as an input, e.g., a graph that is indicative of the molecular structure of a chemical compound.

A CNN or other variety of ANN could include multiple convolutional layers (e.g., corresponding to respective different filters and/or features), pooling layers, rectification layers, fully connected layers, or other types of layers. Rectification layers of an ANN apply a rectifying nonlinear function (e.g., a non-saturating activation function, a sigmoid function) to outputs of a higher layer. Fully connected layers of an ANN receive inputs from many or all of the neurons in one or more higher layers of the ANN. The outputs of neurons of one or more fully connected layers (e.g., a final layer of an CNN, GCN, or other type of ANN) could be used to determine information about portions of an input (e.g., portions of an input image) or for the input as a whole.

Neurons in an ANN can be organized according to corresponding dimensions of the input structure. For example, where the input is an image, neurons of the NN (e.g., of an input layer of the ANN, of a pooling layer of the ANN) could correspond to locations within the image (e.g., pixels, sets of pixels, etc.). Connections between neurons and/or filters in different layers of the ANN could be related to such locations. For example, a neuron in a convolutional layer of the ANN could receive an input that is based on a convolution of a filter with a portion of the input image, or with a portion of some other layer of the ANN, that is at a location proximate to the location within the overall image of the portion of the convolutional-layer neuron. In another example, a neuron in a pooling layer of the ANN could receive inputs from neurons, in a layer higher than the pooling layer (e.g., in a convolutional layer, in a higher pooling layer), that have locations that are proximate to the location of the pooling-layer neuron.

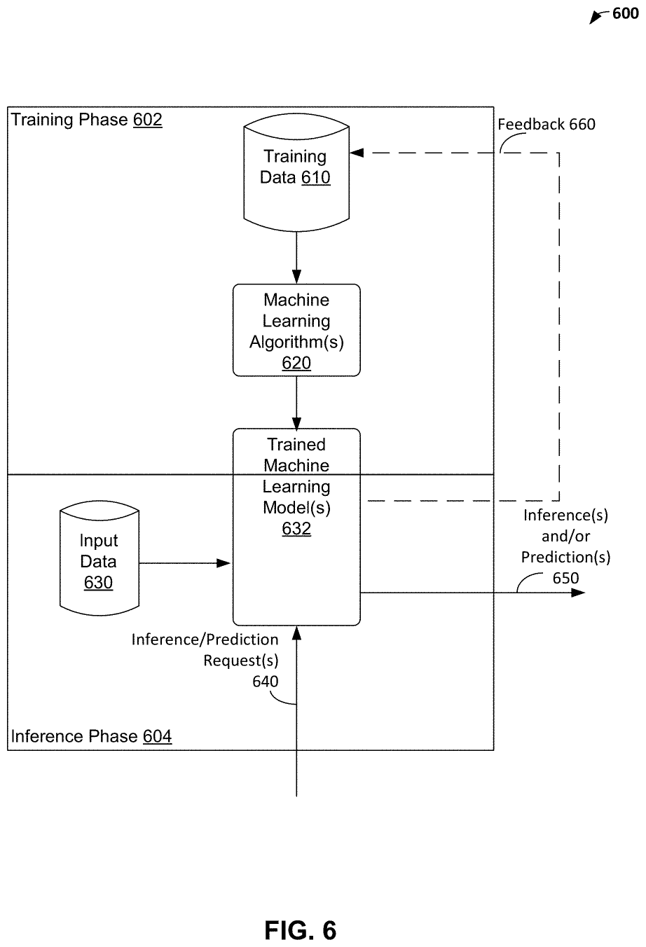

FIG. 6 shows diagram 600 illustrating a training phase 602 and an inference phase 604 of trained machine learning model(s) 632, in accordance with example embodiments. Some machine learning techniques involve training one or more machine learning algorithms, on an input set of training data to recognize patterns in the training data and provide output inferences and/or predictions about (patterns in the) training data. Such output could take the form of “ground truth” observations about the correct classification for the inputs, e.g., an indication of whether a particular user update to a map is incorrect and/or fraudulent. The resulting trained machine learning algorithm can be termed as a trained machine learning model. For example, FIG. 6 shows training phase 602 where one or more machine learning algorithms 620 are being trained on training data 610 to become trained machine learning model 632. Then, during inference phase 604, trained machine learning model 632 can receive input data 630 and one or more inference/prediction requests 640 (perhaps as part of input data 630) and responsively provide as an output one or more inferences and/or predictions 650 (e.g., predictions as to whether inputs are authentic, correct, incorrect, and/or fraudulent).

As such, trained machine learning model(s) 632 can include one or more models of one or more machine learning algorithms 620. Machine learning algorithm(s) 620 may include, but are not limited to: an artificial neural network (e.g., a herein-described graph neural network, convolutional network, and/or graph convolutional network, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. Machine learning algorithm(s) 620 may be supervised or unsupervised, and may implement any suitable combination of online and offline learning.

In some examples, machine learning algorithm(s) 620 and/or trained machine learning model(s) 632 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 620 and/or trained machine learning model(s) 632. In some examples, trained machine learning model(s) 632 can be trained, reside and execute to provide inferences on a particular computing device, and/or otherwise can make inferences for the particular computing device.

During training phase 602, machine learning algorithm(s) 620 can be trained by providing at least training data 610 as training input using unsupervised, supervised, semi-supervised, and/or reinforcement learning techniques. Unsupervised learning involves providing a portion (or all) of training data 610 to machine learning algorithm(s) 620 and machine learning algorithm(s) 620 determining one or more output inferences based on the provided portion (or all) of training data 610. Supervised learning involves providing a portion of training data 610 to machine learning algorithm(s) 620, with machine learning algorithm(s) 620 determining one or more output inferences based on the provided portion of training data 610, and the output inference(s) are either accepted or corrected based on correct results associated with training data 610. In some examples, supervised learning of machine learning algorithm(s) 620 can be governed by a set of rules and/or a set of labels for the training input, and the set of rules and/or set of labels may be used to correct inferences of machine learning algorithm(s) 620.

Semi-supervised learning involves having correct results for part, but not all, of training data 610. During semi-supervised learning, supervised learning is used for a portion of training data 610 having correct results, and unsupervised learning is used for a portion of training data 610 not having correct results. Reinforcement learning involves machine learning algorithm(s) 620 receiving a reward signal regarding a prior inference, where the reward signal can be a numerical value. During reinforcement learning, machine learning algorithm(s) 620 can output an inference and receive a reward signal in response, where machine learning algorithm(s) 620 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 620 and/or trained machine learning model(s) 632 can be trained using other machine learning techniques, including but not limited to, incremental learning and curriculum learning.

During inference phase 604, trained machine learning model(s) 632 can receive input data 630 and generate and output one or more corresponding inferences and/or predictions 650 about input data 630. As such, input data 630 can be used as an input to trained machine learning model(s) 632 for providing corresponding inference(s) and/or prediction(s) 650. For example, trained machine learning model(s) 632 can generate inference(s) and/or prediction(s) 650 in response to one or more inference/prediction requests 640. In some examples, trained machine learning model(s) 632 can be executed by a portion of other software. For example, trained machine learning model(s) 632 can be executed by an inference or prediction daemon to be readily available to provide inferences and/or predictions upon request.

### IV. Conclusion

It should be understood that arrangements described herein are for purposes of example only. As such, those skilled in the art will appreciate that other arrangements and other elements (e.g. machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

What is claimed is:

1. A computer-implemented method comprising:
obtaining input data, wherein the input data includes a plurality of input samples;
assigning each input sample of the input data to a respective slice of a plurality of slices;
for each slice in the plurality of slices, obtaining a respective at least one constraint and a respective at least one metric;
obtaining a trained machine learning model;
determining a respective output threshold value for each slice in the plurality of slices, wherein determining a particular output threshold value for a particular slice in the plurality of slices comprises:
applying each input sample of the input data that corresponds to the particular slice to the trained machine learning model to generate a plurality of model outputs corresponding to the particular slice;
determining at least two putative values of the particular output threshold value that, when applied to the plurality of model outputs corresponding to the particular slice, satisfy the at least one constraint for the particular slice; and
selecting, from the at least two putative values, the particular output threshold value for the particular slice by determining which of the at least two putative values, when applied to the plurality of model outputs corresponding to the particular slice, result in a maximal value of the at least one metric for the particular slice; and
providing the respective output threshold value determined for each slice in the plurality of slices for application with the trained machine learning model.

2. The computer-implemented method of claim 1, further comprising:
obtaining an additional input sample;
applying the additional input sample to the trained machine learning model to generate an additional model output;
determining that the additional input sample corresponds to the particular slice; and
responsive to determining that the additional input sample corresponds to the particular slice, applying the particular output threshold value to the additional model output to determine, for the additional input sample, a classification.

3. The computer-implemented method of claim 2, wherein the input sample represents an input from the user, and wherein the method further comprises:
based on the classification determined for the additional input, accepting the input from the user as authentic.

4. The computer-implemented method of claim 3, wherein the input from the user represents an update to a map, and wherein accepting the input from the user as authentic comprises updating a map database based on the update to the map.

5. The computer-implemented method of claim 1, wherein determining at least two putative values of the particular output threshold value that, when applied to the plurality of model outputs corresponding to the particular slice, satisfy the at least one constraint for the particular slice comprises:
determining whether each possible threshold value of a discrete set of possible values of the particular output threshold value, when applied to the plurality of model outputs corresponding to the particular slice, satisfies the at least one constraint for the particular slice, wherein the discrete set of possible values of the particular output threshold value span a range of values.

6. The computer-implemented method of claim 1, further comprising:
obtaining at least one secondary metric for the particular slice,
wherein selecting, from the at least two putative values, the particular output threshold value for the particular slice comprises:
determining that at least two candidate values of the at least two putative values, when applied to the plurality of model outputs corresponding to the particular slice, result in the same maximal value of the at least one metric for the particular slice; and
selecting, from the at least two candidate values, the particular output threshold value for the particular slice by determining which of the at least two candidate values, when applied to the plurality of model outputs corresponding to the particular slice, result in a maximal value of the at least one secondary metric for the particular slice.

7. The computer-implemented method of claim 1, wherein determining which of the at least two putative values, when applied to the plurality of model outputs corresponding to the particular slice, result in a maximal value of the at least one metric for the particular slice comprises applying respective weights to the model outputs corresponding to the particular slice when computing values of the at least one metric for the at least two putative values.

8. The computer-implemented method of claim 1, further comprising:
for each slice of the plurality of slices, determining a respective output calibration, and wherein applying each input sample of the input data that corresponds to the particular slice to the trained machine learning model to generate a plurality of model outputs corresponding to the particular slice comprises:
applying the each input sample of the input data that corresponds to the particular slice to the trained machine learning model to generate a plurality of raw model outputs; and
applying the plurality of raw model outputs to a particular output calibration determined for the particular slice to generate the plurality of model outputs corresponding to the particular slice.

9. The computer-implemented method of claim 8, wherein determining the particular output calibration for the particular slice comprises determining a Platt calibration for the plurality of raw model outputs.

10. The computer-implemented method of claim 8, wherein determining the particular output calibration for the particular slice comprises:
using each raw model output to update a corresponding bucket of a plurality of buckets, wherein each bucket of the plurality of buckets represents a respective non-overlapping range of possible model output values; and
determining the particular output calibration for the particular slice based on the plurality of buckets.

11. The computer-implemented method of claim 10, wherein each bucket of the plurality of buckets represents: (i) a respective count of raw model outputs assigned to the bucket and corresponding to a first class of inputs, (ii) a respective count of raw model outputs assigned to the bucket and corresponding to a second class of inputs, (iii) a respective sum of weights of raw model outputs assigned to the bucket and corresponding to a first class of inputs, and (iv) a respective sum of weights of raw model outputs assigned to the bucket and corresponding to a second class of inputs.

12. The computer-implemented method of claim 1, further comprising:
obtaining additional input data corresponding to the particular slice; and
updating the particular output threshold value for the particular slice based on the additional input data.

13. The computer-implemented method of claim 1, further comprising:
obtaining an updated machine learning model; and
determining an updated output threshold value for the particular slice by:
applying each input sample of the input data that corresponds to the particular slice to the updated machine learning model to generate a plurality of updated model outputs corresponding to the particular slice;
determining at least two updated putative values of the updated output threshold value that, when applied to the plurality of updated model outputs corresponding to the particular slice, satisfy the at least one constraint for the particular slice; and
selecting, from the at least two updated putative values, the updated output threshold value for the particular slice by determining which of the at least updated two putative values, when applied to the plurality of updated model outputs corresponding to the particular slice, result in a maximal value of the at least one metric for the particular slice.

14. The computer-implemented method of claim 1, wherein obtaining the trained machine learning model comprises training the machine learning model using at least one input sample of the of the input data that corresponds to each slice of the plurality of slices.

15. A computing device comprising:
a controller comprising one or more processors; and
a non-transitory computer readable medium having stored therein instructions executable by the controller device to cause the one or more processors to perform controller operations comprising:
obtaining input data, wherein the input data includes a plurality of input samples;
assigning each input sample of the input data to a respective slice of a plurality of slices;
for each slice in the plurality of slices, obtaining a respective at least one constraint and a respective at least one metric;
obtaining a trained machine learning model;
determining a respective output threshold value for each slice in the plurality of slices, wherein determining a particular output threshold value for a particular slice in the plurality of slices comprises:
applying each input sample of the input data that corresponds to the particular slice to the trained machine learning model to generate a plurality of model outputs corresponding to the particular slice;
determining at least two putative values of the particular output threshold value that, when applied to the plurality of model outputs corresponding to the particular slice, satisfy the at least one constraint for the particular slice; and
selecting, from the at least two putative values, the particular output threshold value for the particular slice by determining which of the at least two putative values, when applied to the plurality of model outputs corresponding to the particular slice, result in a maximal value of the at least one metric for the particular slice; and
providing the respective output threshold value determined for each slice in the plurality of slices for application with the trained machine learning model.

16. An article of manufacture including a non-transitory computer-readable medium, having stored thereon program instructions that, upon execution by a computing device, cause the computing device to perform operations comprising:
obtaining input data, wherein the input data includes a plurality of input samples;
assigning each input sample of the input data to a respective slice of a plurality of slices;
for each slice in the plurality of slices, obtaining a respective at least one constraint and a respective at least one metric;
obtaining a trained machine learning model;
determining a respective output threshold value for each slice in the plurality of slices, wherein determining a particular output threshold value for a particular slice in the plurality of slices comprises:
applying each input sample of the input data that corresponds to the particular slice to the trained machine learning model to generate a plurality of model outputs corresponding to the particular slice;
determining at least two putative values of the particular output threshold value that, when applied to the plurality of model outputs corresponding to the particular slice, satisfy the at least one constraint for the particular slice; and
selecting, from the at least two putative values, the particular output threshold value for the particular slice by determining which of the at least two putative values, when applied to the plurality of model outputs corresponding to the particular slice, result in a maximal value of the at least one metric for the particular slice; and
providing the respective output threshold value determined for each slice in the plurality of slices for application with the trained machine learning model.

17. The article of manufacture of claim 16, wherein the controller operations further comprise:
obtaining an additional input sample;
applying the additional input sample to the trained machine learning model to generate an additional model output;
determining that the additional input sample corresponds to the particular slice; and
responsive to determining that the additional input sample corresponds to the particular slice, applying the particular output threshold value to the additional model output to determine, for the additional input sample, a classification.

18. The article of manufacture of claim 17, wherein the input sample represents an input from the user, and wherein the controller operations further comprise:
based on the classification determined for the additional input, accepting the input from the user as authentic.

19. The article of manufacture of claim 16, wherein the controller operations further comprise:
for each slice of the plurality of slices, determining a respective output calibration, and wherein applying each input sample of the input data that corresponds to the particular slice to the trained machine learning model to generate a plurality of model outputs corresponding to the particular slice comprises:
applying the each input sample of the input data that corresponds to the particular slice to the trained machine learning model to generate a plurality of raw model outputs; and
applying the plurality of raw model outputs to a particular output calibration determined for the particular slice to generate the plurality of model outputs corresponding to the particular slice.

20. The article of manufacture of claim 19, wherein determining the particular output calibration for the particular slice comprises:
using each raw model output to update a corresponding bucket of a plurality of buckets, wherein each bucket of the plurality of buckets represents a respective non-overlapping range of possible model output values; and
determining the particular output calibration for the particular slice based on the plurality of buckets.
